(19) United States
(12) Patent Application Publication
(10) Pub. No.: US 2011/0132393 A1
(43) Pub. Date: Jun. 9, 2011

(54) ARRANGEMENT FOR DISPENSING DENTAL FLOSS

(76) Inventor: Mark Nicholas WHITE, Kwa Zulu Natal (ZA)

(21) Appl. No.: 12/633,036

(22) Filed: Dec. 8, 2009

(51) Int. Cl. A61C 15/04

(52) U.S. Cl. 132/325

(57) ABSTRACT

An arrangement for dispensing dental floss consisting of a container and a cocoon of wound dental floss therein. The cocoon is unwound from an aperture though the centre thereof and the arrangement therefore does not need a hub formed within the container to rotatably mount a spool with floss, as is the case in current arrangements. Doing away with this requirement saves considerable space within the container and therefore substantially less material is required to mould the container. Assembly of the arrangement is also subsequently less expensive.

### FIELD OF THE INVENTION

This invention relates to an arrangement for dispensing dental floss.

### BACKGROUND TO THE INVENTION

Conventional packaging and dispensers for dental floss comprise a spool about which the floss is wound, rotatably mounted on a hub located within a container. In use the floss is wound off the spool through an opening in the container, and usually cut with a small metal blade provided for this purpose on the outer surface of the container.

The container usually includes an integrally moulded cap which is hinged at on end and engages the container at the other end. The function of this cap is to seal the dispensing opening and the blade when not in use.

Examples of these types of dispensers include:

WO2007017194 (Broecker et al.) for a Dental Floss Dispenser which is similar to the arrangement described above but which is characterized in that the device or the elements of the device are produced in a multi-component injection moulding process, and that the device/dispenser is made from more than one material.

In WO9316654 (Spencer et al.) the dispenser is moulded to include two hinged sections, much like that described above. This dispenser is however adapted so that it can be easily opened by the user and the spool of floss can be replaced. This dispenser also includes a window though which the level of the floss can be determined.

WO0207643 (Spark Innovations Inc) describes a slightly different dispenser with an alternative to the above cutting member (blade), but the floss itself is dispensed from a spool or a reel as described in this invention.

In WO0115621 (McConnell) the floss carrying spool member includes an arm which extends across the opening to act as a guide for the floss.

The disadvantage of all of these inventions lies in the fact that the floss is dispensed from a spool or a reel. The spool is necessary to ensure even dispensing of the floss and to avoid entanglement.

The spool necessitates a much larger container as it greatly increases the size of the rolled floss. It further necessitates a hub or a stub shaft on which the spool can rotate to facilitate dispensing.

All of these extra components require extra material in the moulding process, while the need for an integral hub requires a much more complicated mould or template.

This extra material increases production cost, while the complicated moulds and subsequent assembly cost of the spool and the container exacerbates this production cost.

It is an object o this invention to provide an alternative to the above dispensing arrangements which obviates the need for a spool, and which can therefore greatly reduce production cost and carbon emissions.

### THE INVENTION

According to the invention an arrangement for dispensing dental floss comprises a cocoon of dental floss housed within a container; the cocoon being formed to include an aperture located along the longitudinal axis thereof, the end of the floss located within the aperture being accessible to permit unraveling of the floss from the centre of the cocoon; the container including an opening though which the floss is dispensed, and a cutting member.

The container may be moulded as a single unit from a suitable thermoplastic material, while the cutting member may comprise metal. It may be formed without a shaft or hub therein, but the inner form may be similar to that of the cocoon to ensure a relatively tight fit.

The container may include a lid to seal the floss and the cutting member, but it will be appreciated that this is not as necessary as with prior arrangements since the floss is removed from within the cocoon and therefore remains relatively clean.

Since the floss is used from within the cocoon, it retains its shape and size through use and space within the container is therefore not wasted. The shape of the cocoon also allows for a much smaller container, which may typically be cylindrical or rectangular.

Use of this arrangement may also allow for the manufacture a much more compact or so-called ‘travel sized’ dental floss dispensers.

### EMBODIMENT OF THE INVENTION

An embodiment of the invention is described below with reference to the accompanying drawings, in which:

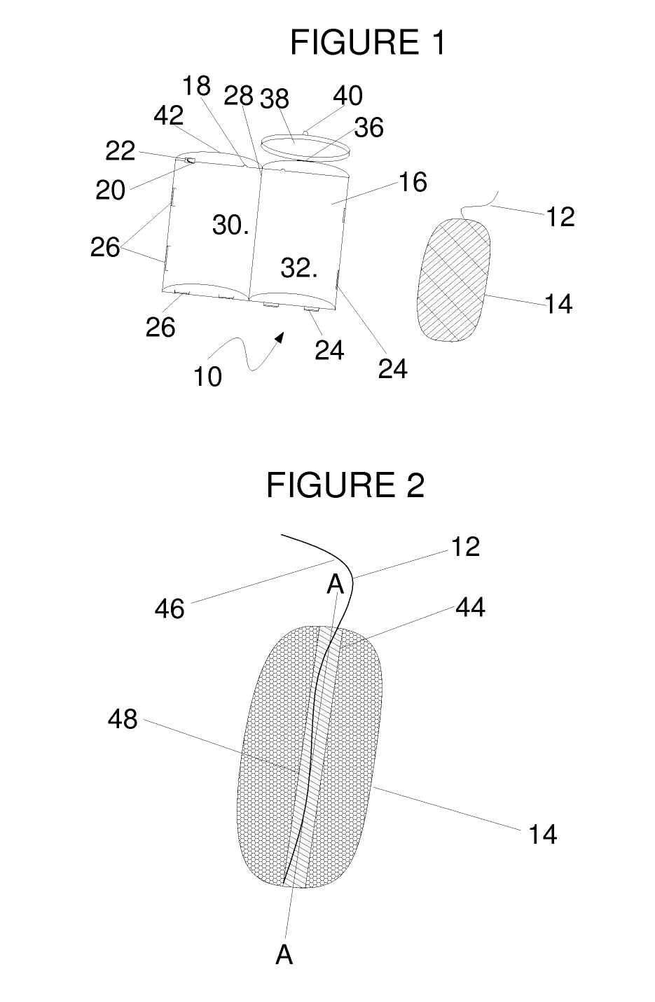

FIG. 1 is an exploded view of a dental floss dispensing arrangement according to the invention;

FIG. 2 is a sectional side view of the cocoon; and

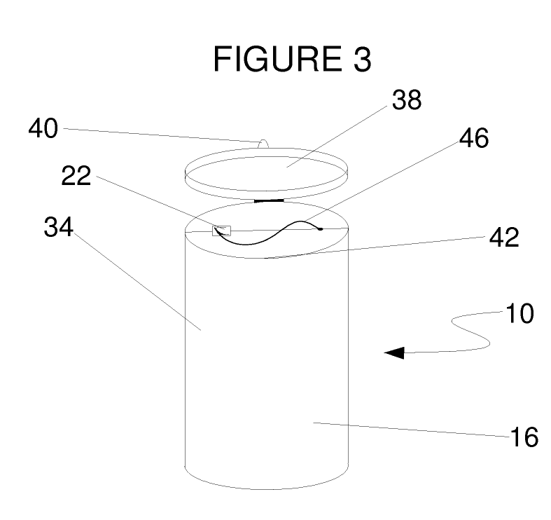

FIG. 3 is a similar view of an assembled arrangement.

In the drawings a dispenser 10 for dental floss 12 comprises a cocoon 14 of floss housed within a container 16.

The container includes an opening 18 through which the floss is dispensed and a cutting member 20, preferably in the form of a metal blade 22. The container also includes protrusions 24 and corresponding recesses 26 which are integrally moulded and used to snap the container closed. A hinged portion 28 is provided between the two elements 30 and 32 which will form the body 34 of the container, while a second hinge 36 is formed between the body and the cap 38 of the container. The cap includes a protrusion 40 for engaging the lip 42 of the container, and thereby sealing off the floss when not in use.

The cocoon (FIG. 2) includes an aperture 44 located along the longitudinal axis thereof indicated by the line AA. The end 46 of the floss is located within the aperture and is accessible to allow for unraveling of the floss from the centre 48 of the cocoon.

In use a hollow container can be formed due to the fact that the floss is not on a reel or a spool and therefore does not need any additional material for forming a hub or a stub shaft. A user may simply apply tension to the end of the floss extending though the opening and once the desired length is unwound from the centre of the cocoon it can be cut using the blade.

1. An arrangement for dispensing dental floss characterized in that it comprises a cocoon of dental floss housed within a container; the cocoon being formed to include an aperture located along the longitudinal axis thereof, the end of the floss located within the aperture being accessible to permit unraveling of the floss from the centre of the cocoon; the container including an opening though which the floss is dispensed, and a cutting member.

2. An arrangement for dispensing dental floss according to claim 1 in which the container is formed without a shaft or hub therein.

3. An arrangement for dispensing dental floss according to claim 1 characterized in that the floss is removed or unwound from within the cocoon.

4. An arrangement for dispensing dental floss according to claim 1 characterized in that the cocoon retains its shape and size through.

5. An arrangement for dispensing dental floss according to claim 1 characterized in that the container is cylindrical.

6. (canceled)

7. An arrangement for dispensing dental floss according to claim 2 characterized in that the floss is removed or unwound from within the cocoon.

8. An arrangement for dispensing dental floss according to claim 2 characterized in that the cocoon retains its shape and size through.

9. An arrangement for dispensing dental floss according to claim 2 characterized in that the container is cylindrical.
